(19) United States
(12) Patent Application Publication
(10) Pub. No.: US 2010/0051839 A1
(43) Pub. Date: Mar. 4, 2010

(54) MAGNET VALVE

(76) Inventors: Harald Guggenmos, Immenstadt/Seifen (DE); Florian Rispler, Hirschegg (AT); Christoph Kasper, Charleston, SC (US); Guenther Schnalzger, Blaichach (DE); Martin Kirschner, Blaichach (DE)

Correspondence Address: RONALD E. GREIGG;GREIGG & GREIGG P.L.L.C., 1423 POWHATAN STREET, UNIT ONE, ALEXANDRIA, VA, 22314, US

(21) Appl. No.: 12/514,398

(22) PCT Filed: Sep. 26, 2007
(86) PCT No.: PCT/EP2007/060214

§ 371 Date: May 11, 2009

(30) Foreign Application Priority Data
Nov. 16, 2006 (DE) 10 2006 054 185.5

(51) Int. Cl. F16K 31/06

(52) U.S. Cl. 251/129.02; 251/129.01

(57) ABSTRACT

The invention relates to a solenoid valve comprising a magnetic assembly and a valve cartridge. The valve cartridge comprises a capsule, a valve insert connected to the capsule and an armature that is mobile in the capsule. The armature includes a tappet having a first closing element. A magnetic force produced by the magnetic assembly displaces the armature towards the valve insert. As a result, the first closing element sealingly plunges into a main valve seat. The valve insert is configured as a valve insert sleeve into which a valve sleeve including the main valve seat is disposed.

### PRIOR ART

The invention relates to a magnet valve as generically defined by the preamble to independent claim 1.

A conventional magnet valve, in particular for a hydraulic unit, which is used for instance in an anti-lock brake system (ABS) or a traction control system (TC system) or an electronic stability program system (ESP system), is shown in FIG. 1. As seen from FIG. 1, the conventional magnet valve 1, which is open when without current, includes a magnet assembly 2 for generating a magnetic flux, which in turn includes a housing jacket 3, a winding holder 4, a coil winding 5, and a cover disk 6, and a valve cartridge 10, which includes a capsule 11, a valve insert 12, embodied for instance as a cold-forged part, an armature 13 with a tappet 14, and a restoring spring 15. The magnet assembly 2 generates a magnetic force, which moves the longitudinally movable armature 13 with the tappet 14 counter to the force of the restoring spring 15 toward the valve insert 12. The coil winding 5 wound onto the winding holder 4 forms an electrical coil, which is triggerable via electrical terminals 7. The valve insert 12 conducts the magnetic flux, introduced from the magnet assembly 2 via the cover disk 6, axially across an air gap 8 in the direction of the armature 13. By supplying current to the coil winding 5 via the electrical terminals 7 and by means of the resultant magneticflux, the armature 13 is moved toward the valve insert 12 counter to the force of the restoring spring 15. In addition, the valve insert 12 receives a precise valve body 16, which includes a main valve seat 17 into which the tappet 14 dips in a sealing fashion, via a first closing element 14.1 embodied as a sealing ball, in order to realize the sealing function of the magnet valve 1. As can also be seen from FIG. 1, a lower valve part 20 made from plastic is inserted into the valve body 16 that is made for instance as a steel part, and this lower part has a valve seat 21 of a check valve, and the check valve performs a directionally oriented flow function. The lower valve part 20 takes on the tasks of both guiding a second closing element 22 for the check valve, and sealing 24 relative to the fluid assembly 60 in which the magnet valve 1 is wedged. The stroke of the second closing element 22 is limited by a stroke limiter 23 or system that is inserted into the lower valve part 20.

### DISCLOSURE OF THE INVENTION

The magnet valve according to the invention, having the characteristics of independent claim 1, has the advantage over the prior art that a valve insert is embodied as a valve insert sleeve into which a valve sleeve that includes a main valve seat is thrust. The valve insert sleeve and the valve sleeve can advantageously be made by the economical technique of deep drawing, and the actual valve seat can be made in the deep-drawn part by a forming operation, preferably stamping. The valve insert sleeve and the valve sleeve with the main valve seat are part of a valve cartridge of the magnet valve of the invention, and this cartridge for instance further includes a capsule, which is connected to the valve insert sleeve, and an armature, disposed movably inside the capsule, and the armature includes a tappet with a first closing element. In addition, the magnet valve of the invention includes a magnet assembly, which generates a magnetic force that moves the armature in the direction of the valve insert sleeve, as a result of which the first closing element dips sealingly into the main valve seat and closes it.

By the provisions and refinements recited in the dependent claims, advantageous improvements to the magnet valve defined by independent claim 1 are possible.

It is especially advantageous that the valve sleeve is embodied as a deep-drawn part, in which the main valve seat and a check valve seat are made by a forming operation, preferably stamping. Alternatively, the valve sleeve can be embodied as a deep-drawn part open at the bottom, into which a valve body in which the main valve seat and a check valve seat are disposed is thrust. In a her alternative, a first filter can include the check valve seat. For opening and closing the check valve seat, there is for instance a second closing element, which is preferably embodied as a sealing ball and closes or opens the check valve seat as a function of the flow direction of a volumetric flow. The stroke of the second closing element can be limited for instance by the first filter.

In a feature of the magnet valve of the invention, a first volumetric flow presses the second closing element sealingly into the check valve seat, and the first volumetric flow is regulated by the first closing element, which cooperates with the main valve seat. A second volumetric flow, which relative to the first volumetric flow flows in the opposite direction, presses the second closing element out of the check valve seat and opens the check valve seat.

In a further feature of the magnet valve of the invention, a bracing segment is integrally formed onto the valve sleeve, and a restoring spring, counter to whose force the armature is movable in the direction of the valve insert sleeve is braced on this bracing segment. As a result, the restoring spring can be located outside the flow region, in the upper region of the valve insert sleeve. In addition, the valve cartridge can be wedged to a wedging region in a fluid assembly, via a wedging flange integrally formed onto the valve insert sleeve, and the valve sleeve or the first filter provides sealing off from the fluid assembly via a press fit and bring about a separation of the fluid circuits.

Advantageous embodiments of the invention that are described below, as well as the conventional exemplary embodiment described above for the sake of better comprehension of the invention, are shown in the drawings. In the drawings, identical reference numerals designate components and elements that have the same or analogous functions.

### BRIEF DESCRIPTION OF THE DRAWINGS

FIG. 1 shows a schematic sectional view of a conventional magnet valve.

FIG. 2 shows a schematic sectional view of a first exemplary embodiment of a valve cartridge of a magnet valve of the invention.

FIG. 3 shows a schematic sectional view of a second exemplary embodiment of a valve cartridge of a magnet valve of the invention.

FIG. 4 shows a schematic sectional view of a third exemplary embodiment of a valve cartridge of a magnet valve of the invention.

### EMBODIMENTS OF THE INVENTION

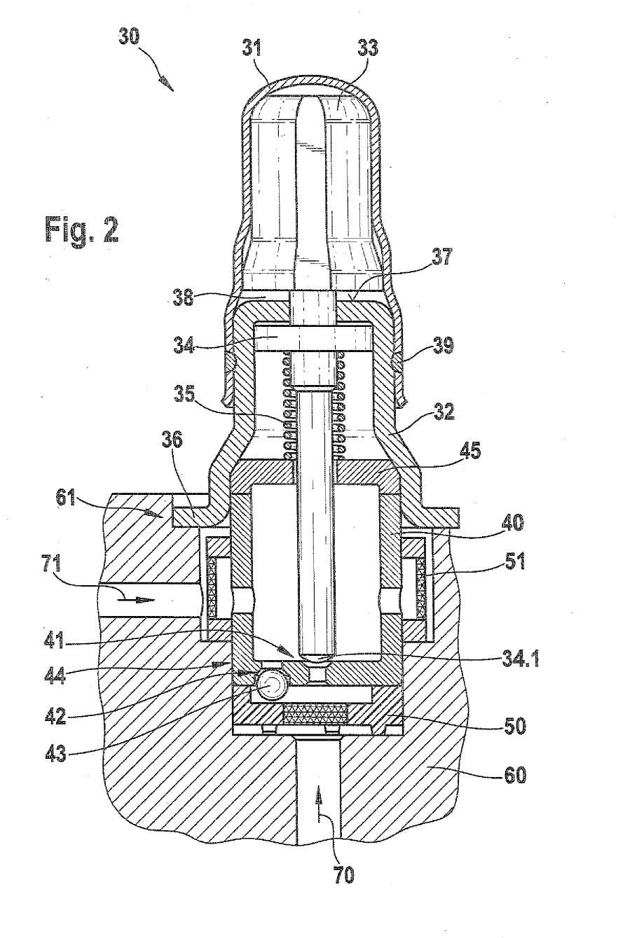

As can be seen from FIG. 2, a first exemplary embodiment of a valve cartridge 30 for a magnet valve of the invention, for instance for a magnet valve that is open when without current, includes a capsule 31, a valve insert sleeve 32 embodied as a deep-drawn part, an armature 33 with a tappet 34 and a first closing element 34.1, a restoring spring 35, and a valve sleeve 40 with a main valve seat 41 and a check valve seat 42. The valve sleeve 40 is for example likewise embodied as a deep-drawn part, in which the main valve seat 41 and the check valve seat 42 are made by a forming operation, preferably stamping. The capsule 31, in which the armature 33 is guided longitudinally movably, is slipped onto the valve insert sleeve 32 and secured to the valve insert sleeve 32 by a sealing weld 39, such as a laser-welded seam. The sealing weld 39 furthermore serves to seal off from the outside. By means of a magnetic force, generated by a magnet assembly not shown here, and a magnetic flux guided via an air gap 38, the armature 33 is attracted axially toward a pole face 37 of the valve insert sleeve 32, counter to the force of the restoring spring 35 that is braced on a bracing segment 45 integrally formed onto the valve sleeve 40. As a result of this motion of attraction, the end of the tappet 34 embodied as a first closing element 34.1 is thrust into the main valve seat 41 of the valve sleeve 40, so that a first volumetric flow 70, which presses from beneath against the first closing element 34.1, embodied for instance as a sealing dome, can be regulated. The restoring spring 35 keeps the main valve seat 41 open in the currentless state.

To attain a larger flowthrough area, a check valve with the check valve seat 42 is mounted in the valve sleeve 40 and can be opened and closed as a function of the flow direction of the volumetric flow by a second closing element 43, which is embodied for instance as a sealing ball. Thus the check valve performs a directionally oriented flow function. In the exemplary embodiment shown, the second closing element 43 closes the check valve seat 42 when the first volumetric flow 70 is present, and it opens the check valve seat 42 when a second volumetric flow 71 is present, which has a flow direction that is opposite the flow direction of the first volumetric flow 70. In addition, the stroke of the second closing element 43 is limited by a first filter 50 disposed below the check valve seat 42; this filter is embodied for instance as a flat filter aid additionally fixes the position of the second closing element 43. The first filter, embodied as a flat filter, filters the first volumetric flow 70, and a second filter 51, embodied for instance as a radial filter, filters the second volumetric flow 71.

As can also be seen from FIG. 2, the valve cartridge 30 of the magnet valve of the invention is wedged on a wedging region 61 in the fluid assembly 60, via a wedging flange 36 integrally formed onto the valve insert sleeve 32; the valve sleeve 40 seals off from the fluid assembly 60 via a press fit 44 and thereby performs a separation of the fluid circuits.

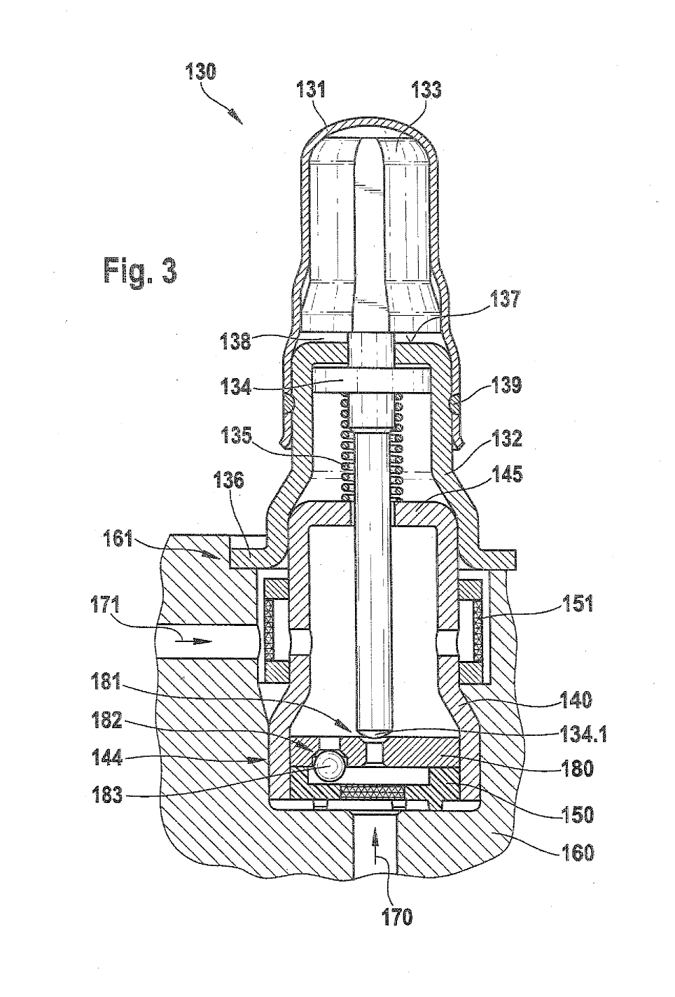

As can be seen from FIG. 3, a second exemplary embodiment of a valve cartridge 130 for a magnet valve of the invention, analogously to the first exemplary embodiment of FIG. 2, includes a capsule 131, a valve insert sleeve 132 embodied as a deep-drawn part, an armature 133 with a tappet 134 and a first closing element 134.1, a restoring spring 135, and a valve sleeve 140. Unlike the valve sleeve 40 of the first exemplary embodiment, the valve sleeve 140 is embodied as a deep-drawn part open at the bottom, into which a valve body 180 having a main valve seat 181 and a check valve seat 182 is thrust. The valve body 180 having the main valve seat 181 and the check valve seat 182 can be embodied for instance as a punched part or stamped part. The capsule 131, in which the armature 133 is guided longitudinally movably, is slipped onto the valve insert sleeve 132 and secured to the valve insert sleeve 132 by a sealing weld 139, such as a laser-welded seam; the sealing weld 139 additionally seals off from the outside. By means of a magnetic force, generated by a magnet assembly not shown here, and a magnetic flux guided via an air gap 138, the armature 133 is attracted axially toward a pole face 137 of the valve insert sleeve 132, counter to the force of the restoring spring 135 that is braced on a bracing segment 145 integrally formed onto the valve body 180. As a result of this motion of attraction, the end of the tappet 134 embodied as a first closing element 134.1 is thrust into the main valve seat 181 of the valve body 180, so that a first volumetric flow 170, which presses from beneath against the first closing element 134.1, embodied for instance as a sealing dome, can be regulated. The restoring spring 135 keeps the main valve seat 181 open in the currentless state.

To attain a larger flowthrough area, a check valve with the check valve seat 182 is mounted in the valve body 180 and can be opened and closed as a function of the flow direction of the volumetric flow by a second closing element 183, which is embodied for instance as a sealing ball. Thus the check valve performs a directionally oriented flow function. In the exemplary embodiment shown, the second closing element 183 closes the check valve seat 182 when the first volumetric flow 170 is present, and it opens the check valve seat 182 when a second volumetric flow 171 is present, which has a flow direction that is opposite the flow direction of the first volumetric flow 170. In addition, by means of a first filter 150 disposed below the check valve seat 182, the stroke of the second closing element 183 is limited and the position of the second closing element 183 is fixed. The second filter 150 is embodied for instance as a flat filter and is likewise thrust into the valve sleeve 140 that is open at the bottom. The first filter 150, embodied as a flat filter, filters the first volumetric flow 170, and a second filter 151, embodied for instance as a radial filter, filters the second volumetric flow 171.

As can be further seen from FIG. 3, the valve cartridge 130 of the magnet valve of the invention is wedged on a wedging region 161 in the fluid assembly 160, via a wedging flange 136 integrally formed onto the valve insert sleeve 132; the valve sleeve 140 seals off from the fluid assembly 160 via a press fit 144 and thereby performs a separation of the fluid circuits.

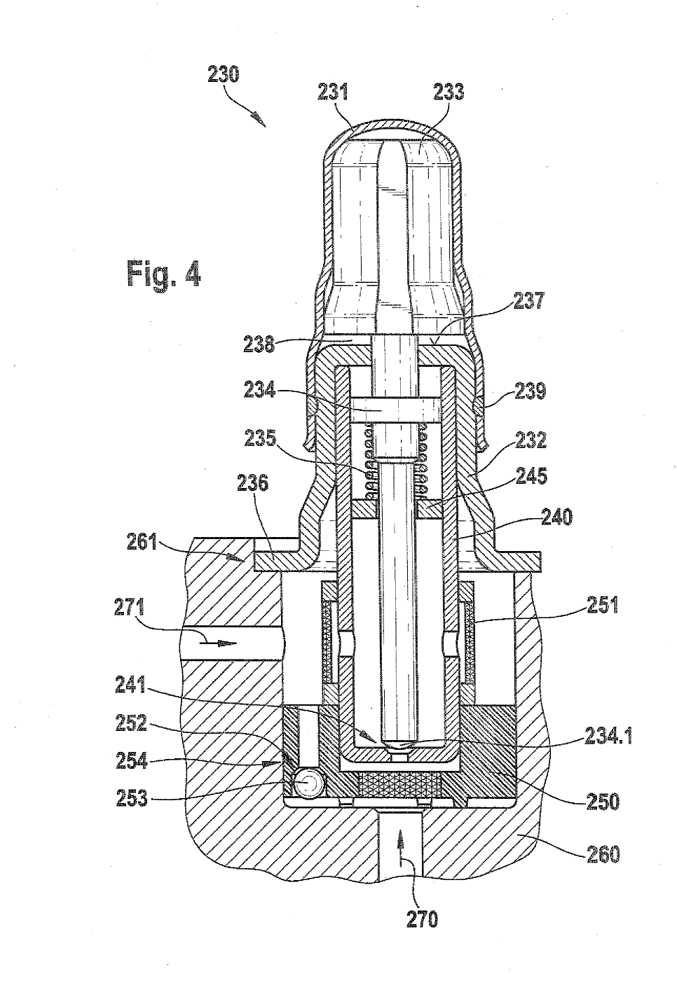

As can be seen from FIG. 4, a third exemplary embodiment of a valve cartridge 230 for a magnet valve of the invention, analogously to the first and second exemplary embodiments of FIGS. 2 and 3, includes a capsule 231, a valve insert sleeve 232 embodied as a deep-drawn part, an armature 233 with a tappet 234 and a first closing element 234.1, a restoring spring 235, and a valve sleeve 240. Unlike the valve sleeve 40 of the first exemplary embodiment, the valve sleeve 240 is likewise embodied as a deep-drawn part and unlike the valve sleeve 40 of the first exemplary embodiment and the valve sleeve 140 of the second exemplary embodiment, it includes only one main valve seat 241, which is made in the valve sleeve 240 by a forming operation, preferably stamping, while a check valve seat 252 is disposed in a first filter 250 that is slipped onto the valve sleeve 240. The capsule 231, in which the armature 233 is guided longitudinally movably, is slipped onto the valve insert sleeve 232 and secured to the valve insert sleeve 232 by a sealing weld 239, such as a laser-welded seam. The sealing weld 239 furthermore serves to seal off from the outside. By means of a magnetic force, generated by a magnet assembly not shown here, and a magnetic flux guided via an air gap 238, the armature 233 is attracted axially toward a pole face 237 of the valve insert sleeve 232, counter to the force of the restoring spring 235 that is braced on a bracing segment 245 integrally formed onto the valve sleeve 240. As a result of this motion of attraction, the end of the tappet 234 embodied as a first closing element 234.1 is thrust into the main valve seat 241 of the valve sleeve 240, so that a first volumetric flow 270, which presses from beneath against the first closing element 234.1, embodied for instance as a sealing dome, can be regulated. The restoring spring 235 keeps the main valve seat 241 open in the currentless state.

To attain a larger flowthrough area, a check valve with the cheek valve seat 252 is disposed in the first filter 250, which is slipped onto the valve sleeve 240. The check valve seat 252 can be opened and closed as a function of the flow direction of the volumetric flow by a second closing element 253, which is embodied for instance as a sealing ball. Thus the check valve performs a directionally oriented flow function. In the exemplary embodiment shown, the second closing element 253 closes the check valve seat 252 when the first volumetric flow 270 is present, and it opens the check valve seat 252 when a second volumetric flow 271 is present, which has a flow direction that is opposite the flow direction of the first volumetric flow 270. In addition, the stroke of the second closing element 253 inside the first filter 250 is limited. The first filter 250 can for instance be embodied as a flat filter and can fix the position of the second closing element 253. The first filter 250 embodied as a flat filter filters the first volumetric flow 270, and a second filter 251 embodied for instance as a radial filter filters the second volumetric flow 271.

As can be further seen from FIG. 4, the valve cartridge 230 of the magnet valve of the invention is wedged on a wedging region 261 in the fluid assembly 260, via a wedging flange 236 integrally formed onto the valve insert sleeve 232; and first filter 250 slipped onto the valve sleeve 240 seals off from the fluid assembly 260 via a press fit 254 and thereby performs a separation of the fluid circuits.

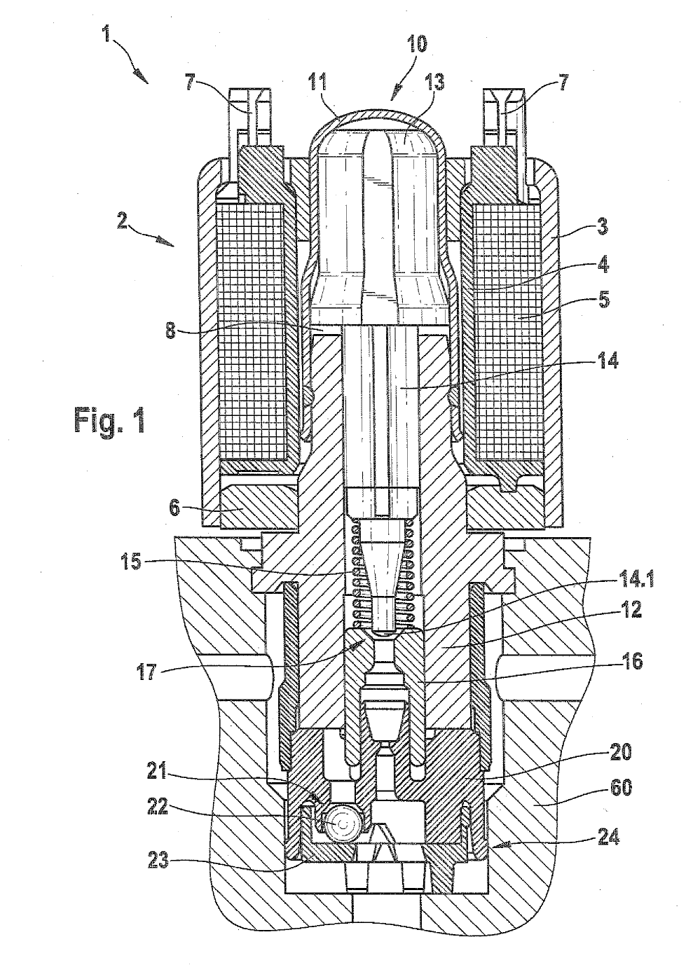

The magnet assembly, not shown, that generates the magnetic force and the magnetic flux in order to move the armature 33, 133, 233 in the respective exemplary embodiment of the valve cartridge 30, 130, 230, when current is supplied, toward the pole face 37, 137, 237 of the valve insert sleeve 32, 132, 232, can be embodied analogously to the magnet assembly 2 shown in FIG. 1 and can include a housing jacket 3, a winding holder 4, a coil winding 5, and a cover disk 6, and the coil winding 5 wound onto the winding holder 4 forms an electrical coil, which is triggerable via electrical terminals 7.

The magnet valve of the invention advantageously has a smaller number of components, which in contrast to plastic parts are less vulnerable to fluctuations in temperature and humidity and have no tendency to swell. Thus not only the main valve seat but also the check valve seat can be stamped into the valve sleeve of the invention. In addition, by the valve insert sleeve and the valve sleeve of the magnet valve of the invention, which are made as deep-drawn parts, economical precision parts can be made available that can replace complicated turned or cold-forged parts.

The magnet valve of the invention can be used for instance in fluid assemblies that are employed in an anti-lock brake system (ABS) or a traction control system (TC system) or an electronic stability program system (ESP system).

1-10. (canceled)

11. A magnet valve having a magnet assembly and a valve cartridge,
the valve cartridge including a capsule, a valve insert connected to the capsule, and an armature disposed movably inside the capsule,
the armature including a tappet with a first closing element, a magnetic force generated by the magnet assembly moving the armature in the direction of the valve insert, causing the closing element to dip sealingly into a main valve seat, wherein the valve insert is embodied as a valve insert sleeve, into which a valve sleeve that includes the main valve seat is thrust.

12. The magnet valve as defined by claim 11, wherein the valve sleeve is embodied as a deep-drawn part, into which the main valve seat and a check valve seat are introduced by a forming operation.

13. The magnet valve as defined by claim 11, wherein the valve sleeve is embodied as a deep-drawn part open at the bottom, into which a valve body in which the main valve seat and a check valve seat are disposed is thrust.

14. The magnet valve as defined by claim 11, wherein a first filter includes a check valve seat.

15. The magnet valve as defined by claim 12, including a second closing element, which closes or opens the check valve seat as a function of a flow direction of a volumetric flow.

16. The magnet valve as defined by claim 13, including a second closing element, which closes or opens the check valve seat as a function of a flow direction of a volumetric flow.

17. The magnet valve as defined by claim 14, including a second closing element, which closes or opens the check valve seat as a function of a flow direction of a volumetric flow.

18. The magnet valve as defined by claim 15, wherein the stroke of the second closing element is limited by a first filter.

19. The magnet valve as defined by claim 16, wherein the stroke of the second closing element is limited by a first filter.

20. The magnet valve as defined by claim 17, wherein the stroke of the second closing element is limited by a first filter.

21. The magnet valve as defined by claim 15, wherein a first volumetric flow, regulated by the first closing element, presses the second closing element sealingly into the check valve seat.

22. The magnet valve as defined by claim 18, wherein a first volumetric flow, regulated by the first closing element, presses the second closing element sealingly into the check valve seat.

23. The magnet valve as defined by claim 20, wherein a first volumetric flow, regulated by the first closing element, presses the second closing element sealingly into the check valve seat.

24. The magnet valve as defined by claim 15, wherein a second volumetric flow presses the second closing element out of the check valve seat and opens the check valve seat.

25. The magnet valve as defined by claim 18, wherein a second volumetric flow presses the second closing element out of the check valve seat and opens the check valve seat.

26. The magnet valve as defined by claim 21, wherein a second volumetric flow presses the second closing element out of the check valve seat and opens the check valve seat.

27. The magnet valve as defined by claim 11, wherein a bracing segment is integrally formed onto the valve sleeve, and a restoring spring, counter to whose force the armature is movable in the direction of the valve insert sleeve, is braced on this bracing segment.

28. The magnet valve as defined by claim 13, wherein a bracing segment is integrally formed onto the valve sleeve, and a restoring spring, counter to whose force the armature is movable in the direction of the valve insert sleeve, is braced on this bracing segment.

29. The magnet valve as defined by claim 11, wherein the valve cartridge, via a wedging flange integrally formed onto the valve insert sleeve, is wedged on a wedging region in a fluid assembly and seals off the valve sleeve from the fluid assembly via a press fit.

30. The magnet valve as defined by claim 14, wherein the valve cartridge, via a wedging flange integrally formed onto the valve insert sleeve, is wedged on a wedging region in a fluid assembly and seals off the first filter from the fluid assembly via a press fit.
